(19) United States
(12) Patent Application Publication
(10) Pub. No.: US 2011/0034056 A1
(43) Pub. Date: Feb. 10, 2011

(54) Electrical Connector

(76) Inventor: Yoshihiko Kodaira, Kanagawa (JP)

Correspondence Address: BARLEY SNYDER, LLC, 1000 WESTLAKES DRIVE, SUITE 275, BERWYN, PA, 19312, US

(21) Appl. No.: 12/910,489

(22) Filed: Oct. 22, 2010

Related U.S. Application Data
(63) Continuation of application No. PCT/JP2009/055765, filed on Mar. 24, 2009.

(30) Foreign Application Priority Data
Apr. 25, 2008 (JP) 2008-115803

(51) Int. Cl. H01R 13/62; H01R 24/00

(52) U.S. Cl. 439/329; 439/660

(57) ABSTRACT

An electrical connector that alleviates limitations on a mounting position on a circuit board while maintaining a reduced height. The electrical connector includes a housing, a contact, and an actuator. The housing includes a front end and an opening into which a tip of a flexible printed circuit board having a connecting conductor at the tip is inserted. The contact is supported by the housing, and includes a solder connection portion exposed from the housing and a contact portion in a lower position in the opening to contact the connecting conductor of the flexible printed circuit board. The actuator is positioned in the housing, while a protrusion section, in the housing, adjusts upward a body portion of the flexible printed circuit board when inserted into the opening. The actuator is rotatable between an open position in which the tip of the flexible printed circuit board is allowed to be inserted into the opening and a closed position in which the connecting conductor at the tip of the flexible printed circuit board inserted into the opening is pressed against the contact portion.

### CROSS-REFERENCE TO RELATED APPLICATIONS

This application is a continuation of PCT International Application No. PCT/JP2009/055765, filed Mar. 24, 2009, which claims priority under 35 U.S.C. §119 to Japanese Patent Application No. JP 2008-115803, filed Apr. 25, 2008.

### FIELD OF THE INVENTION

The present invention relates to an electrical connector and in particular an electrical connector to which a flexible printed circuit board is connected.

### BACKGROUND

In recent years, as electronic devices such as mobile phones or digital cameras, which have become smaller and thinner, often use a flexible printed circuit board (hereinafter referred to as FPC). The FPC is a flat, flexible cable having a connecting conductor at a tip thereof. The FPC is connected to an electrical connector provided on a circuit board of an electronic device.

A known electrical connector is disclosed in Japanese Patent Laid-Open No. 2003-151660, which proposes an electrical connector in which an actuator is rotated to press an FPC against a contact for connection. FIGS. 8A and 8B shown an electrical connector 100, as disclosed in Japanese Patent Laid-Open No. 2003-151660, connecting to a FPC 2 that is mounted to a circuit board 3.

The known electrical connector 100 includes a housing 110 having an opening 110b into which the FPC 2 is inserted and a housing body 110a. The housing 110 is formed by molding insulating resin. The FPC 2 has a tip 2a having a connecting conductor 2b exposed on a lower surface and a reinforcing resin member 2c on an upper surface, and a body portion 2d being connected to the tip 2a.

The known electrical connector 100 also includes a contact 120 supported by the housing body 110a. The contact 120 is formed by stamping a conductive sheet metal, and press-fitted and fixed to the housing body 110a from a rear of the housing 110. The contact 120 includes a board portion 122, a lower arm 126 extending forward from a lower end of the board portion 122, and an upper elastic arm 130 extending forward from an upper end of the board portion 122. A solder connection portion 124 exposed from the housing 110 is formed in a rear end of the board portion 122. The solder connection portion 124 is connected by solder to the circuit board 3. Further, a contact portion 128 is positioned in a lower position in the opening 110b and formed in a front end of the lower arm 126, so that the contact portion 128 makes contact with the connecting conductor 2b of the FPC 2 that is inserted into the opening 110b.

The known electrical connector 100 also includes an actuator 140. The actuator 140 includes a rotation shaft 142. The actuator 140 is configured to be rotatable around the rotation shaft 142 between an open position shown in FIG. 8A and a closed position shown in FIG. 8B with respect to the housing 110.

As shown in FIG. 8A, where the actuator 140 is in the open position, the FPC 2 can be inserted into the opening 110b with the connecting conductor 2b of the tip 2a in the FPC 2 facing downward. Then, the actuator 140 is rotated in a direction of arrow A. Then, as shown in FIG. 8B, the FPC 2 having been inserted into the opening 110b is pressed from above by an outline portion of the actuator 140, bringing the connecting conductor 2b of the FPC 2 into contact with the contact portion 128 with contact pressure required for electrical connection. As such, the FPC 2 is connected to the known electrical connector 100.

However, with the known electrical connector 100, as shown in FIG. 8B, there is only a slight space S between the FPC 2 and the circuit board 3 in the state where the actuator 140 is in the closed position. Thus, it is difficult to mount an electronic component 4 on a side where the FPC 2 is inserted as shown in FIG. 8A. Thus, because it is difficult to arrange the electrical connector 100 in a center of the circuit board 3, an arrangement restriction is applied such that the electrical connector 100 has to be placed on an end of the circuit board 3. Then, in order to make it possible to arrange the electrical connector also in a center section of the circuit board, it is conceivable that the electrical connector is increased in height.

FIG. 9 shows an electrical connector having an increased height and connecting with an FPC. Incidentally, the same components as those in FIG. 8 are denoted by the same reference numerals, and different points will be described.

As compared with the electrical connector 100 shown FIGS. 8A and 8B, an electrical connector 200, shown in FIGS. 9A and 9B, includes a contact 222 having a large height and a housing 210 with a housing body 210a having a large height, and as a result the electrical connector 200 is thus increased in height. For this reason, in the electrical connector 200, the FPC 2 may be easily inserted into an opening 210b even if the electronic component 4 is mounted on a side where the FPC 2 is inserted. Since a large space is ensured between the FPC 2 and a circuit board 3, when an actuator 140 is in a closed position, the electronic component 4 may be arranged. Thus, the electrical connector 200 may be placed in a center of the circuit board 3.

In addition, Japanese Utility Model Laid-Open No. H5-69881 discloses an electrical connector in which a slidably mounted slide cover presses an FPC inserted from obliquely upward against a contact for locking.

In the above-described electrical connector 200, shown in FIG. 9, even if the electrical connector 200 is arranged in a center of the circuit board 3, the electronic component may be placed on the side where the FPC is inserted. However, the electrical connector 200 needs to be increased in height. Thus, it is difficult to make compatible ensuring flexibility of placement of components on the circuit board with reducing the height of the electrical connector to which the FPC is connected.

In the electrical connector proposed in Japanese Utility Model Laid-Open No. H5-69881, the contact which contacts with a connecting conductor of the FPC is located on an upper side. Generally, an FPC is often incorporated in which a connecting conductor is oriented downward. Thus, if the electrical connector proposed in Japanese Utility Model Laid-Open No. H5-69881 is used, the FPC originally facing downward needs to be twisted or bent to be oriented upward and then the FPC needs to be inserted into the electrical connector. Thus, there is poor workability and also disadvantageous to housing space. In addition, because the slide cover slides in an oblique direction and further the slide cover is arranged under the FPC, there is a problem in which the operability is poor.

### SUMMARY

In view of the above-described circumstances, an object of the invention, among others, is to provide an electrical connector in which a restriction of a mounting position on a circuit board is alleviated while maintaining a reduced height.

The electrical connector includes a housing, a contact, and an actuator. The housing includes a front end and an opening into which a tip of a flexible printed circuit board having a connecting conductor at the tip is inserted. The contact is supported by the housing, and includes a solder connection portion exposed from the housing and a contact portion in a lower position in the opening to contact the connecting conductor of the flexible printed circuit board. The actuator is positioned in the housing, while a protrusion section, in the housing, adjusts upward a body portion of the flexible printed circuit board when inserted into the opening. The actuator is rotatable between an open position in which the tip of the flexible printed circuit board is allowed to be inserted into the opening and a closed position in which the connecting conductor at the tip of the flexible printed circuit board inserted into the opening is pressed against the contact portion.

### BRIEF DESCRIPTION OF THE DRAWINGS

The invention is described in more detail in the following with reference to the embodiments shown in the drawings. Similar or corresponding details in the Figures are provided with the same reference numerals. The invention will be described in detail with reference to the following figures of which:

FIG. 1A is a sectional view of a front contact side of an electrical connector according to the invention;

FIG. 1B is another sectional view of the front contact side of the electrical connector of FIG. 1A;

FIG. 2A is a sectional view of a rear contact side of the electrical connector according to the invention;

FIG. 2B is another sectional view of the rear contact side of the electrical connector of FIG. 2A;

FIG. 3 is an external perspective view of the electrical connector according to the invention, when an actuator is in an open position;

FIG. 4 is an external perspective view of the electrical connector according to the invention, when the actuator is in a closed position;

FIG. 5 is an external perspective view of the electrical connector according to the invention from a lateral side when the actuator is in the open position;

FIG. 6 is an external perspective view of the electrical connector according to the invention from a lateral side when the actuator is in the closed position;

FIG. 7A is a cross sectional view of the electrical connector according to the invention when an FPC is inserted and attached;

FIG. 7B is another cross sectional view of the electrical connector according to the invention when the FPC is inserted and attached;

FIG. 8A is a cross sectional view of a known electrical connector connecting with a FPC;

FIG. 8B is another cross sectional view of the known electrical connector of FIG. 8A;

FIG. 9A is a cross sectional view of another known electrical connector connecting with a FPC;

FIG. 9B is another cross sectional view of the known electrical connector of FIG. 9A.

### DETAILED DESCRIPTION OF THE EMBODIMENT(S)

In the following, an embodiment of the present invention will be described with reference to the drawings.

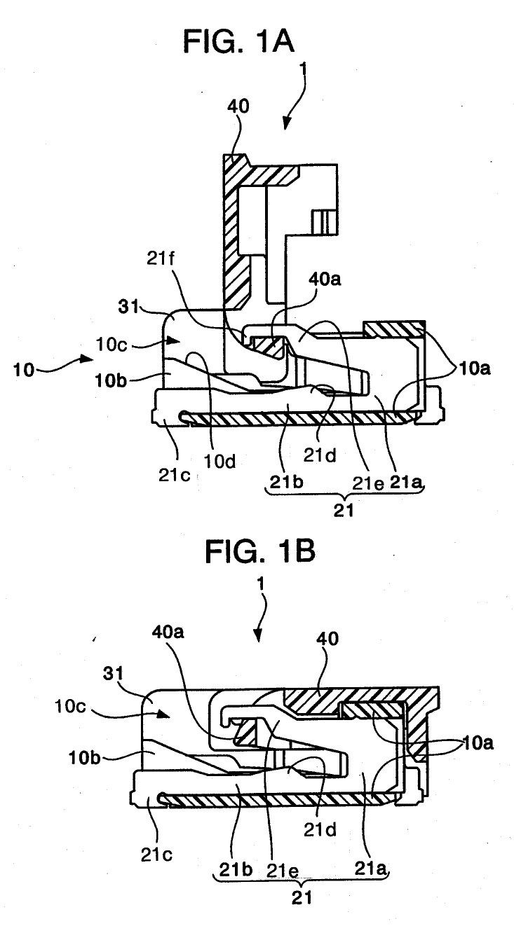

In an electrical connector 1, according to the invention, a front contact 21 and a rear contact 22 are alternately supported by a housing to be attached as described later. First, a configuration on a front contact side of the electrical connector 1 will be described with reference to FIG. 1.

FIG. 1A shows a section on the front contact side of the electrical connector 1 when an actuator 40 is in an open position. FIG. 1B illustrates a section on the front contact side of the electrical connector 1 when the actuator 40 is in a closed position.

The electrical connector 1 shown in FIGS. 1A and 1B includes a housing 10 having an opening 10c into which an FPC described later is inserted with a connecting conductor in the FPC facing downward, a housing body 10a, and a protrusion section 10b extending upward from a lower portion of the housing body 10a. The housing 10 is formed by molding insulative resin.

Specifically, the protrusion section 10b is a member that forms a downward slope 10d protruding upward and extending from an inlet of the opening 10c toward a deep side of the opening 10c, and orients upward a portion connecting with a tip of the FPC inserted into the opening 10c as the portion is away from the housing 10. The downward slope 10d may smoothly guide the FPC inserted from the inlet of the opening 10c toward the deep side.

The electrical connector 1 also includes a front contact 21 supported by the housing body 10a. The front contact 21 is formed by stamping a conductive sheet metal, and press-fitted and fixed to the housing body 10a from a front (left in FIGS. 1A and 1B) of the housing 10. The front contact 21 includes a base plate 21a, a lower arm 21b extending forward from a lower end of the base plate 21a, and an upper elastic arm 21e extending forward from an upper end of the base plate 21a. A solder connection portion 21c exposed from the housing 10 is formed in a front end of the lower arm 21b. Further, substantially in a center of the lower arm 21b, a contact portion 21d is formed that is located in a lower position in the opening 10c, and contacts and conducts with, for example, an odd-numbered connecting conductor at the tip of the FPC inserted into the opening 10c.

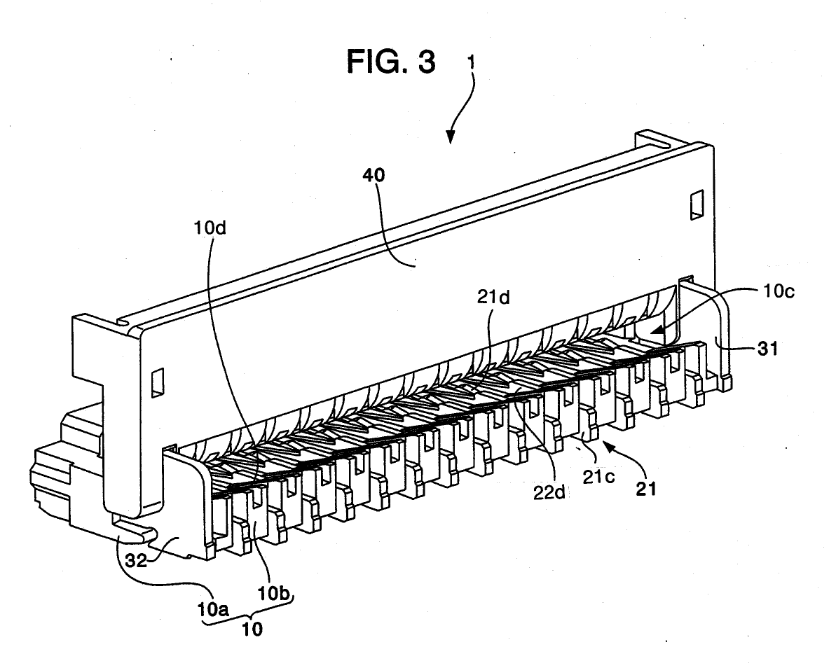

Further, the electrical connector 1 includes metal plates (solder pegs) 31 and 32 (see FIG. 3) mounted so as to be press-fitted and fixed from the front of the housing body 10a. Bottoms of the plates 31 and 32 are connected by solder on a circuit board (not illustrated).

The electrical connector 1 also includes an actuator 40. The actuator 40 has a rotation shaft 40a extending in a direction which is a horizontal direction and which is perpendicular to a direction in which the FPC (not illustrated) is inserted into the opening 10c. The rotation shaft 40a is attached to the plates 31 and 32 at both ends in a longitudinal direction of the actuator 40. The actuator 40 is rotatable around the rotation shaft 40a between an open position where the actuator 40 extends upward with respect to the housing 10 with the rotation shaft 40a facing downward as illustrated in FIG. 1A, and a closed position where the actuator 40 is rotated toward a side opposite to the opening 10c (rearward, that is, right in FIGS. 1A and 1B) and extends rearward from the rotation shaft 40a as illustrated in FIG. 1B. As illustrated in FIG. 1A, when the actuator 40 is in the open position, the FPC may be inserted into the opening 10c. Also, as illustrated in FIG. 1B, when the actuator 40 is in the closed position, the FPC inserted into the opening 10c is pressed from above by the rotation shaft 40a of the actuator 40 so that the odd-numbered connecting conductors of the FPC contacts with the contact portions 21d. Incidentally, a downward hook 21f that prevents removal of the rotation shaft 40a is provided at a tip of the upper elastic arm 21e.

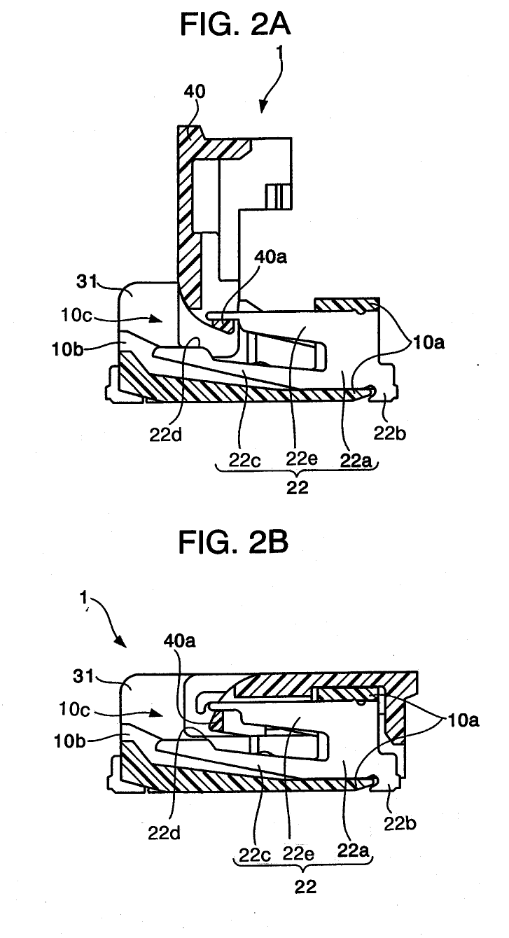

Next, a configuration on a rear contact side of the electrical connector 1 will be described with reference to FIGS. 2A and 2B.

A rear contact 22 is formed by stamping a conductive sheet metal, and press-fitted and fixed to the housing body 10a from a rear of the housing 10. The rear contact 22 includes a base plate 22a, a lower elastic arm 22c extending forward and upward from a lower end of the base plate 22a, and an upper elastic arm 22e extending forward from an upper end of the base plate 22a. A solder connection portion 22b exposed from the housing 10 is formed in a rear end of the base plate 22a. Further, in a front end of the lower elastic arm 22c, a contact portion 22d is formed that is located in a lower position in the opening 10c, and contacts and conducts with an even-numbered connecting conductor of the FPC inserted into the opening 10c.

As shown in FIG. 2A, when the actuator 40 is in the open position, the FPC (not illustrated) may be inserted into the opening 10c. As illustrated in FIG. 2B, when the actuator 40 is in the closed position, the FPC inserted into the opening 10c is pressed from above by the rotation shaft 40a of the actuator 40 so that the even-numbered connecting conductor of the FPC contacts with the contact portion 22d.

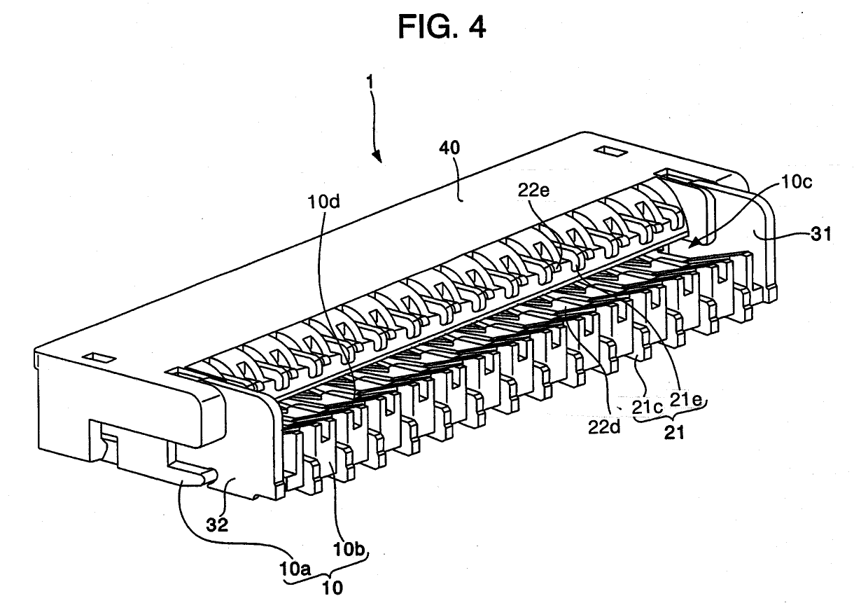

FIGS. 3 and 4 show the opening 10c in the housing 10 included in the electrical connector 1. The FPC (not shown) is inserted into the opening 10c with the connecting conductors in the FPC facing downward.

The housing body 10a extends in a longitudinal direction. Further, as described above, the protrusion section 10b included in the housing 10 extends from the lower portion of the housing body 10a, and forms the downward slope 10d protruding upward and extending from the inlet of the opening 10c toward the deep side of the opening 10c.

In addition, FIG. 3 also shows the solder connection portions 21c and the contact portions 21d included in the front contacts 21 supported by the housing 10, and the contact portions 22d included in the rear contacts 22. FIG. 4 also shows the upper elastic arms 21e included in the front contacts 21, and the upper elastic arms 22e included in the rear contacts 22. The front contacts 21 and the rear contacts 22 are alternately supported by the housing 10 to be mounted.

Further, FIGS. 3 and 4 show the metal plates 31 and 32 attached so as to be press-fitted and fixed from the front to both side walls in the longitudinal direction of the housing body 10a. Bottoms of the plates 31 and 32 are connected on a circuit board (not illustrated) by solder.

The actuator 40 is also illustrated that is rotatable between the open position illustrated in FIG. 3 and the closed position illustrated in FIG. 4 with respect to the housing 10.

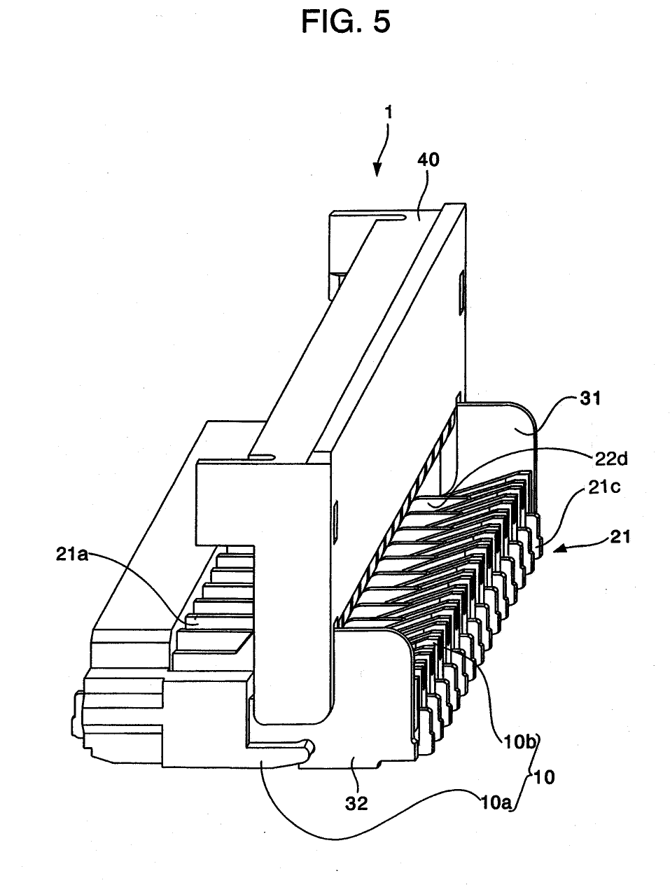

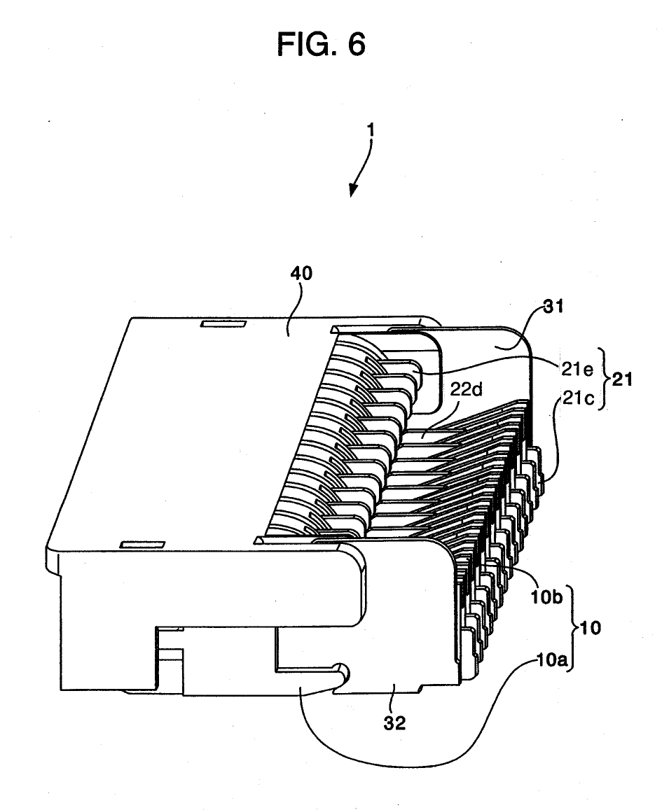

FIG. 5 shows the solder connection portions 21c and the base plates 21a included in the front contacts 21, and the contact portions 22d included in the rear contacts 22. FIG. 6 also shows the upper elastic arms 21e included in the front contacts 21.

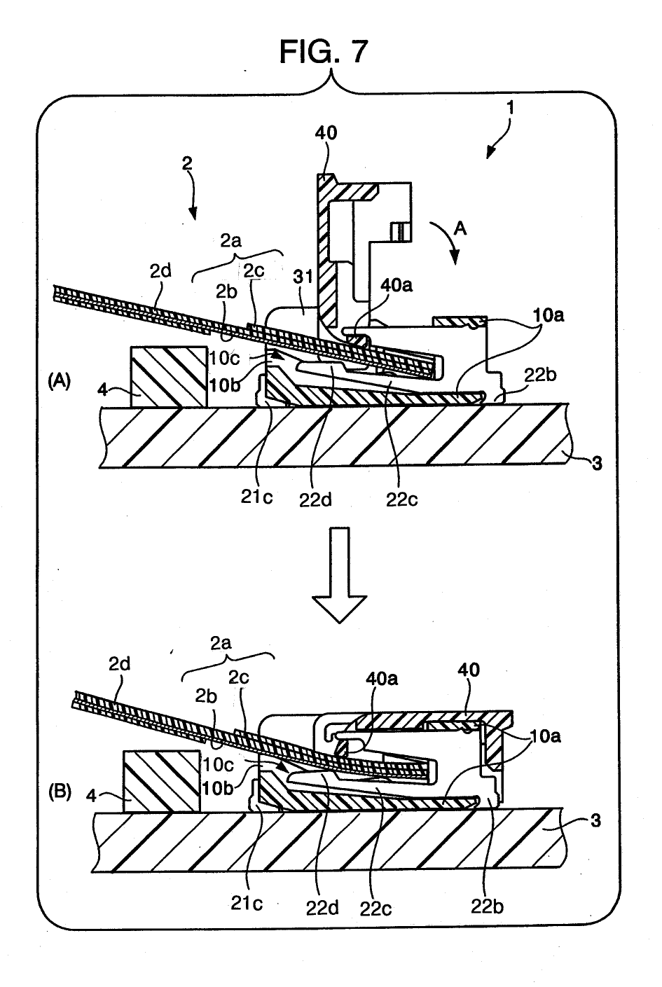

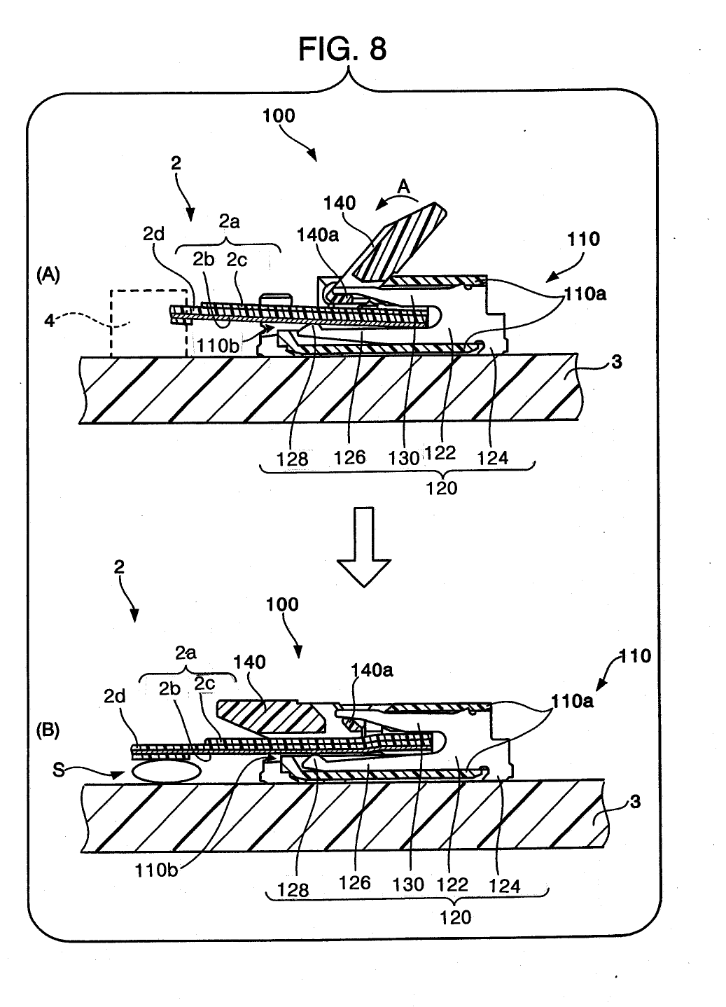

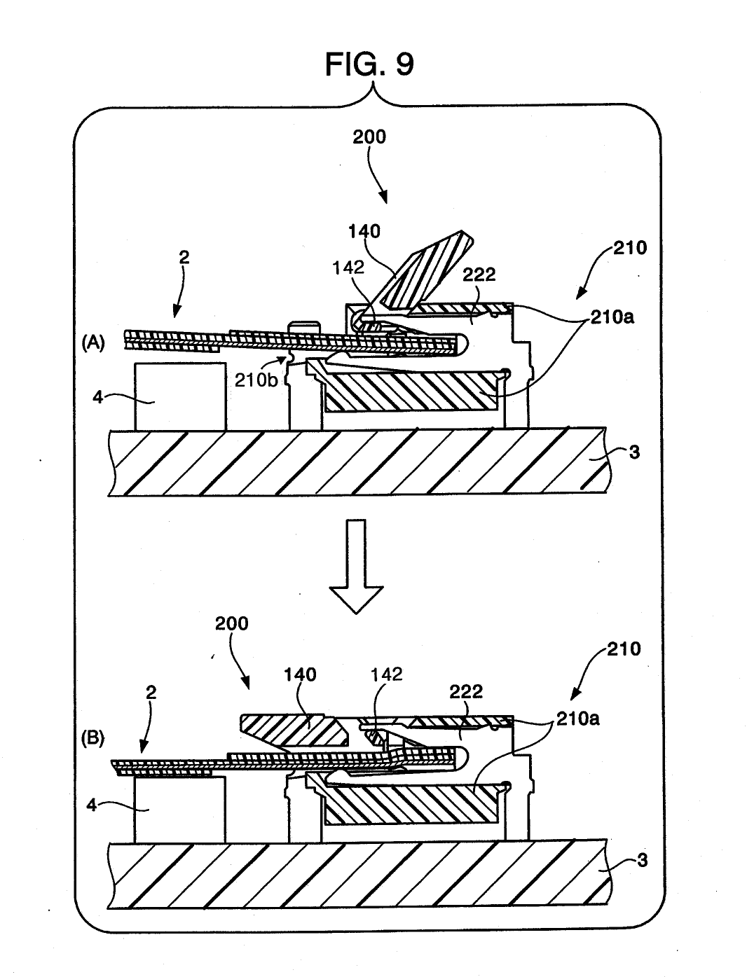

With respect to FIGS. 7A and 7B, the electrical connector 1 is connected by solder to the circuit board 3 by the solder connection portions 21c and 22b. An electronic component 4 is mounted to the circuit board 3 on a side of the opening 10c of the electrical connector 1. FIG. 7 also show a FPC 2 having a tip 2a with a connecting conductor 2b exposed on a lower surface and a reinforcing resin member 2c on an upper surface, as well as a body portion 2d connecting with the tip 2a.

As shown in FIG. 7A, in a state in which the actuator 40 is in the open position, the FPC 2 is inserted into the opening 10c with the connecting conductor 2b at the tip 2a of the FPC 2 facing downward. The electrical connector 1 includes the protrusion section 10b formed with the downward slope extending from the inlet of the opening 10c toward the deep side of the opening 10c. Thus, when the FPC 2 is inserted into the opening 10c, when the actuator 40 is in the open position, the FPC 2 may be smoothly inserted.

Then, the actuator 40 is rotated in a direction of the arrow A. Then, as shown in FIG. 7B, the FPC 2 inserted into the opening 10c is pressed from above by the rotation shaft 40a of the actuator 40, so that the connecting conductor 2b of the FPC 2 is brought into contact with the contact portion 22d with a contact pressure required for electrical connection. As such, the FPC 2 is connected to the electrical connector 1 with high reliability. Here, also when the actuator 40 is in the closed position after the FPC 2 is inserted into the opening 10c, the body portion 2d connecting with the tip 2a of the inserted FPC 2 is oriented upward by the protrusion section 10b as the body portion 2d is away from the housing 10. Thus, the FPC 2 is secured while the FPC also extends obliquely upwardly, away from the electrical connector 1. Thus, as shown in FIGS. 7A and 7B, the electronic component 4 may be arranged near the opening 10c of the electrical connector 1 into which the FPC 2 is inserted. This allows the electrical connector 1 to be placed in the center of the circuit board 3 while maintaining a reduced height of the electrical connector 1. This increases flexibility of design (arrangement of components) on the circuit board by a user.

In the electrical connector 1 according to this embodiment, the height of the protrusion section 10b may be adjusted in design and manufacturing to freely set an orientation of the FPC 2. This may adjust so that the FPC 2 is not brought into contact with the electronic component 4.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. An electrical connector comprising:
a housing having a front end and an opening into which a tip of a flexible printed circuit board having a connecting conductor at the tip is inserted;
a contact supported by the housing;
a solder connection portion of the contact exposed from the housing;
a contact portion of the contact in a lower position in the opening to contact the connecting conductor of the flexible printed circuit board;
an actuator in the housing; and
a protrusion section in the housing adjusting upward a body portion of the flexible printed circuit board when inserted into the opening;
wherein the actuator is rotatable between an open position in which the tip of the flexible printed circuit board is allowed to be inserted into the opening and a closed position in which the connecting conductor at the tip of the flexible printed circuit board inserted into the opening is pressed against the contact portion.

2. The electrical connector according to claim 1, wherein the protrusion section includes a downward slope protruding upward and extending from an inlet of the opening toward a deep side of the opening.

3. The electrical connector according to claim 1, wherein the actuator includes a rotation shaft extending in a horizontal direction and intersects a direction in which the flexible printed circuit board is inserted into the opening.

4. The electrical connector according to claim 1, wherein actuator is rotatable around the rotation shaft.

5. An electrical connector, comprising:
a housing having an opening, a housing body, and a protrusion section extending upward from a lower portion of the housing body; and
a front contact and a rear contact alternately supported by the housing;
wherein the protrusion section forms a downward slope protruding upward and extending from an inlet of the toward a deep side of the opening.

6. The electrical connector according to claim 5, wherein the protrusion section adjusts upward a body portion of a flexible printed circuit board inserted into the opening.

7. The electrical connector according to claim 5, wherein the front contact includes a base plate;
a lower arm extending forward from a lower end of the base plate; and
an upper elastic arm extending forward from an upper end of the base plate.

8. The electrical connector according to claim 7, further comprising a solder connection portion exposed from the housing and in a front end of the lower arm.

9. The electrical connector according to claim 7, further comprising a contact portion in a lower position in the opening.

10. The electrical connector according to claim 9, wherein the contact portion contacts and conducts with an odd-numbered connecting tips of a flexible printed circuit board inserted into the opening.

11. The electrical connector according to claim 9, wherein the rear contact includes
a base plate;
a lower elastic arm extending forward and upward from a lower end of the base plate; and
an upper elastic arm extending forward from an upper end of the base plate.

12. The electrical connector according to claim 11, wherein a solder connection portion exposed from the housing and in a rear end of the base plate.

13. The electrical connector according to claim 12, further comprising a contact portion in a front end of the lower elastic arm and located in a lower position in the opening.

14. The electrical connector according to claim 5, further comprising metal plates press-fitted and fixed from a front of the housing body.

15. The electrical connector according to claim 14, wherein bottoms of the plates connect by solder on a circuit board.

16. The electrical connector according to claim 5, further comprising an actuator which is rotatable between an open position in which a tip of a flexible printed circuit board is allowed to be inserted into the opening and a closed position in which a connecting conductor at the tip of the flexible printed circuit board inserted into the opening is pressed against a contact portion in a lower position in the opening.

17. The electrical connector according to claim 16, wherein the actuator includes a rotation shaft extending in a horizontal direction and intersects a direction in which the flexible printed circuit board is inserted into the opening.

18. The electrical connector according to claim 5, wherein the rear contact includes
a base plate;
a lower elastic arm extending forward and upward from a lower end of the base plate; and
an upper elastic arm extending forward from an upper end of the base plate.

19. The electrical connector according to claim 18, wherein a solder connection portion exposed from the housing and in a rear end of the base plate.

20. The electrical connector according to claim 19, further comprising a contact portion in a front end of the lower elastic arm and located in a lower position in the opening.
